(19) United States
(12) Patent Application Publication
(10) Pub. No.: US 2006/0142504 A1
(43) Pub. Date: Jun. 29, 2006

(54) Novel polymer and production of nano-porous low dielectric polymer composite film using the same

(76) Inventors: Moonhor Ree, Pohang-si Kyungsangbuk-do (KR); Weontae Oh, Pohang-si Kyungsangbuk-do (KR); Yongtaek Hwang, Pohang-si Kyungsangbuk-do (KR); Byeongdu Lee, Pohang-si Kyungsangbuk-do (KR)

Correspondence Address: SUGHRUE MION, PLLC, 2100 PENNSYLVANIA AVENUE, N.W., SUITE 800, WASHINGTON, DC, 20037, US

(21) Appl. No.: 10/561,974

(22) PCT Filed: Feb. 17, 2004
(86) PCT No.: PCT/KR04/00316

§ 371 Date: Dec. 22, 2005

(30) Foreign Application Priority Data
Jun. 25, 2003 (KR) 1020030041384

(51) Int. Cl. C08C 19/00

(52) U.S. Cl. 525/342

(57) ABSTRACT

A star-shaped polymer having an alkoxy silane end group and containing an ether group at the center thereof, which is represented by formula (I), is useful as a pore introducer to obtain a low dielectric silicate polymer film having nano-pores distributed regularly and evenly. The star-shaped polymer is prepared by comprising conducting a ring open polymerization of a cyclic monomer and a polyhydric alcohol, and reacting the resulting polymer with an alkoxy silane compound.

### FIELD OF THE INVENTION

The present invention relates to a star-shaped polymer having ether group at the center thereof and an alkoxysilane end group and the preparing method thereof and the production of a polymer composite film having low dielectric constant using the same.

### BACKGROUND OF THE INVENTION

A multilayer structured high performance integrated circuit generally comprises copper as a conductive material and there has been a need to develop a new material having a dielectric constant of below 2.5, which is substantially lower than silicate dioxide currently used as a dielectric material which has a dielectric constant of about 3.5 to 4.0. Such a low dielectric material can solve the problems of signal delay and cross-talk caused by the drastic scale-down of the integrated circuit. Many attempts have been made to develop such a low dielectric material using a silicate, nano-pore silicate, aromatic polymer, aromatic fluoride polymer or organic-inorganic composite. A dielectric material having a dielectric constant of 2.5 or less useful for a highly integrated semiconductor device is also required to have satisfactory performance characteristics in terms of thermal stability, mechanical and electrical properties, chemical-mechanical polishing (CMP) suitability, etching suitability and interface characteristics.

The production of an insulating material of an ultra low dielectric constant requires the introduction of nano-pores into the insulating materials or a film thereof, and for this object, a polymer compound capable of forming nano-pores by way of conducting thermal decomposition has been attempted. However, in such studies, the control of the size and distribution of nano-pores have yielded unsatisfactory results of the phase separation between the insulating material and the pore generating polymer.

### SUMMARY OF THE INVENTION

Accordingly, it is an object of the present invention to provide star-shaped novel polymer materials capable of generating nano-pores in an insulating film with regularity and uniformity.

In accordance with one aspect of the present invention, there is provided a polymer having the structure of formula (I) which can be used as a nano-pore introducer:

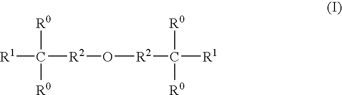

wherein R^{o} is —CH₂O—[CO—(CH₂)ₙ—O]ₘ—X, —CH₂O—[CH₂O]₃ₘ—X, —CH₂O—[(CH₂)ₙ—O]ₘ—X or —CH₂O—[CONH—(CH₂)ₙ]ₘ—X;

X is SiR³ₖ (OR⁴)₃₋ₖ;

R¹ is C₁₋₅ alkyl or R^{o};

R² is C₁₋₄ alkylene or arylene;

R³ and R⁴ are each independently C₁₋₅ alkyl; and

n is an integer in the range of 2 to 5, m is an integer in the range of 2 to 20 and k is an integer in the range of 0 to 2.

In accordance with a further aspect of the present invention, there is provided a method of preparing the polymer represented by formula (I), comprising conducting a ring open polymerization of a cyclic monomer and a polyhydric alcohol, and reacting the resulting polymer with a silane compound such as SiR³ₖ(OR⁴)₃₋ₖ.

In accordance with a further aspect of the present invention, there is provided a method of preparing a polymer composite film of a low dielectric constant containing nano pores, which comprises conducting a sol-gel reaction between a polymer of formula (I) and a silicate polymer, followed by thermal decomposition of the resulting polymer.

### BRIEF DESCRIPTION OF THE DRAWINGS

The above and other objects and features of the present invention will become apparent from the following description of the invention, when taken in conjunction with the accompanying drawings, which respectively show:

FIG. 1: a FT-IR spectrum of polymer A obtained in Example 1;

FIG. 2: a ¹H NMR spectrum of polymer A obtained in Example 1;

FIG. 3: a ¹³C NMR spectrum of polymer A obtained in Example 1;

FIG. 4: a FT-IR spectrum of polymer B obtained in Example 2;

FIG. 5: a ¹H NMR spectrum of polymer B obtained in Example 2;

FIG. 6: a ¹³C NMR spectrum of polymer B obtained in Example 2;

### DETAILED DESCRIPTION OF THE INVENTION

The present invention relates to an organic pore introducer capable of generating nano-pores in a silicate polymer material to obtain a silicate polymer of a low dielectric constant. According to the present invention, the pore size generated in the polymer film can be controlled in the range of a few nanometers and phase separation can be suppressed sufficiently for the resulting pores to distribute homogeneously in the polymer film.

The novel polymer according to the present invention is characterized by having a star shape which can be prepared by ring open polymerization of one of cyclic monomers of formulas (III) to (VI) and a polyhydric alcohol of formula (II), followed by the reaction of the resulting polymer with an alkoxy silane compound.

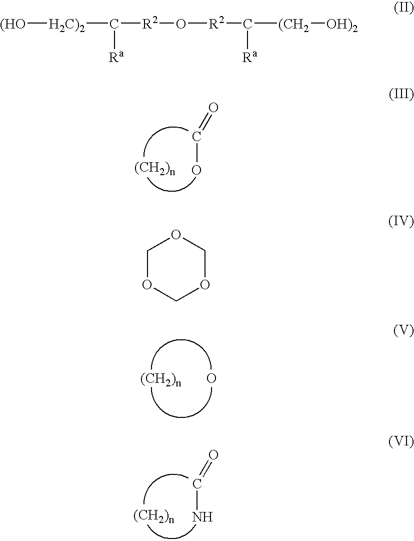

wherein R^{a} is C₁₋₅ alkyl or CH₂OH;

R² is C₁₋₄ alkylene or arylene; and

n is an integer in the range of 2 to 5.

It is preferred that the polyhydric alcohol of formula (II) is di(trimethylolpropane), di(pentaerythritol) or derivatives thereof.

Specially, the inventive star-shaped polymer having a reactive alkoxy (i.e., methoxy or ethoxy) end group can be prepared as follows.

In the 1^{st} step, an organic monomer having the cyclic structures of formula (III) to (VI) is mixed with a polyhydric alcohol of formula (II) with a mixing mole ratio of from 12:1 to 120:1 and the mixture is reacted at a temperature of from 100 to 200°.

For controlling the molecular weight of the star-shaped polymer, the mole ratio of the organic cyclic monomer and polyhydric alcohol can be regulated. It is preferred that a catalyst such as stannous 2-ethyl hexanoate is added to the reaction mixture in an amount of 0.5 to 2% by weight based on the amount of the polyhydric alcohol. By ling open polymerization, a star-shaped polymer having OH end groups can be obtained.

In the 2^{nd} step, a star-shaped polymer of formula (I) can be obtained by reacting the polymer prepared in the 1^{st} step with a silane compound which is preferably an alkoxy silane compound selected from the group consisting of 3-isocyanatopropyl triethoxy silane, 3-glycidoxypropyl dimethylethoxy silane, 3-glycidoxypropyl methyldiethoxy silane and 3-glydoxypropyl methyldimethoxy silane.

It is preferred that the polymer obtained by ring open polymerization is mixed with a silane compound with a mixing mole ratio of 1:0.1 to 1:5, and reacted in an organic solvent, e.g., tetrahydrofuran, toluene, 1,3-dioxane, 1,4-dioxane or a mixture thereof, at 60 to 80° C. One example of the star-shaped polymer having alkoxyl silane end group can be represented by formula (I), and more specific examples are represented by formula (VII) and (VIII).

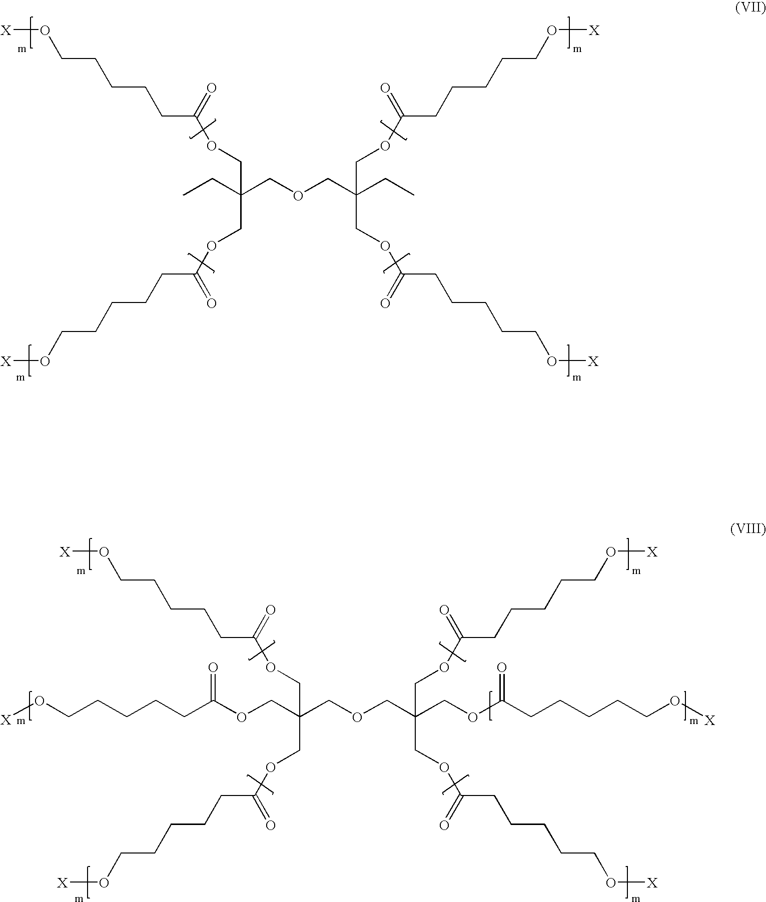

In the formulas (VII) and (VIII), X is SiR³ₖ (OR⁴)₃₋ₖk is an integer in the range of 0 to 2 and m is an integer in the range of 2 to 20.

The star-shaped polymer can be obtained by removing the organic solvent and unreacted impurities and drying the resulting product. The weight averaged molecular weight of the resulting polymer is typically in the range of 500 to 20,000. A polymer having a weight averaged molecular weight below 500 or over 20,000 is not desirable because it does not function effectively as a pore introducer.

When the molecular weight of the polymer is small, the polymer is obtained as a clear liquid of high viscosity, and when large, as a white solid of a low melting point.

In case the degree of polymerization m is below 2, the function as a star-shaped polymer having reactive end groups becomes unsatisfactory, and in case over 20, the mechanical strength of the resulting polymer composite film becomes poor.

Further, the present invention provides a low dielectric constant polymer composite film having nano pores distributed therein by thermally decomposing a mixture of the inventive star-shaped polymer and a silicate polymer The star-shaped polymer having reactive end groups according to present invention can be used to introduce nano-pores into the silicate polymer film.

A silicate polymer, e.g., methylsilsesquioxane, ethylsilsesquioxane or hydrogensilsesquioxane having a weight averaged molecular weight in the range of 3,000 to 20,000 g/mol can be used to prepare the inventive silicate polymer composite film having nano-pores evenly distributed therein.

The star-shaped polymer having reactive end groups of formula (I) can be thermally decomposed at a temperature in the range of 200 to 400° C., and the alkoxy groups thereof can be a reactive couple with alkoxy groups of the silicate polymer such as silsesquioxane to form bonds.

The polymer composite film according to present invention can be prepared by mixing the star-shaped polymer of formula (I) and a silicate polymer in an organic solvent (e.g., methylisobutyl ketone, acetone, methylethyl ketone or toluene) to obtain a homogeneous solution, which is subjected to a sol-gel reaction at 200° C. or below.

The mixing weight ratio by weight of the star-shaped polymer of formula (I) and the silicate polymer is preferably 1:99 to 50:50. In case the star-shaped polymer content is over 50% by weight, the generation of nano-pore becomes ineffective.

The silicate polymer is preferably obtained by a sol-gel reaction of one or more selected from the group consisting of trichloroethane, methyltrimethoxysilane, methyltriethoxysilane, methyldimethoxysilane, ethyltriethoxysilane, ethyltrimethoxysilane, ethyldiethoxysilane, ethyldimethoxysilane, bistrimethoxysilylethane, bistriethoxysilylethane, bistriethoxysilylmethane, bistriethoxysilyloctane and bistrimethoxysilylhexane.

In order to prepare the polymer composite film, a mixture of a silicate polymer and the star-shaped polymer distributed homogeneously in an organic solvent is spin-coated on a substrate, e.g., silicon, and a sol-gel reaction is carried out to form a film of a desired thickness.

As the silicate polymer and the reactive end groups of the star-shaped polymer of formula (I) chemically react with each other, phase separation therebetween does not take place while the star-shaped polymer is completely decomposed under a vacuum or inert gas atmosphere at a temperature ranging from 200 to 500° C. to form nano-pores in the composite film. In case the reaction temperature is under 200° C., thermal curing does not proceed properly, and in case of over 500° C., a thermal decomposition of the polymer composite occurs.

The resulting porous silicate polymer composite film has a refractive index of 1.15 to 1.40 at the wavelength of 633 nm.

The present invention will be described in further detail by the following Examples, which are, however, not intended to limit the scopes of the present invention.

### EXAMPLE 1

### Polymerization of a Polymer Having Formula (VII) and Preparation of a Silsesquioxane Polymer Film Using the Same

40 g (344.5 mmol) of ε-caprolactam and 2 g (8.5 mmol) of 1,1-di(trimethylol)propane were placed in a dried reactor, stirred and heated under a nitrogen atmosphere at 110° C. The mixture formed a clear solution, to which 4 ml of a 1% toluene solution of stannous 2-ethyl hexanoate which corresponded to 0.01 mole equivalent based on di(trimethylol)propane added. The resulting mixture was heated to 110° C. and stirred for 24 hrs at that temperature. After the polymerization was completed, the resulting mixture was dissolved into tetrahydrofuran, and cold methanol was added thereto to recrystallize the polymer, which was separated and dried under a vacuum to obtain a star-shaped 4-brigde polymer of formula (VII) wherein X is H, in a yield of 90%. The polymer had an weight averaged molecular weight(Mw) of 7,000 g/mol.

12 g of the polymer obtained as above was placed in a dried reactor, and 200 ml of tetrahydrofuran was introduced therein to completely dissolve the polymer to obtain a clear and homogeneous solution. 6.0 g of 3-isocyanatopropyl triethoxysilane was added thereto and the resulting solution was stirred for 48 hrs at 60° C. under a nitrogen atmosphere. After the reaction was completed, the solvent was removed under a reduced pressure, and the residue was recrystallized from pentane to obtain the polymer (polymer A) having —OCONH—(CH₂)₃—Si(OC₂H₅)₃ as X in formula (VII) having a molecular weight of 8,000 g/mol in a yield of 90%. The precipitated polymer was separated and dried under a vacuum.

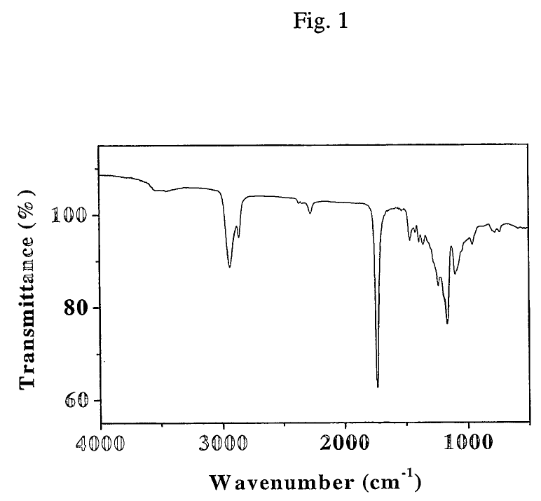

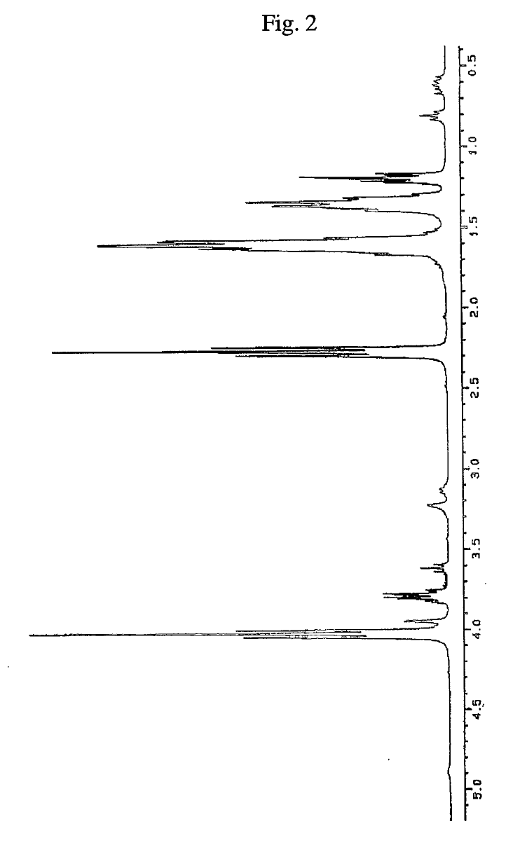

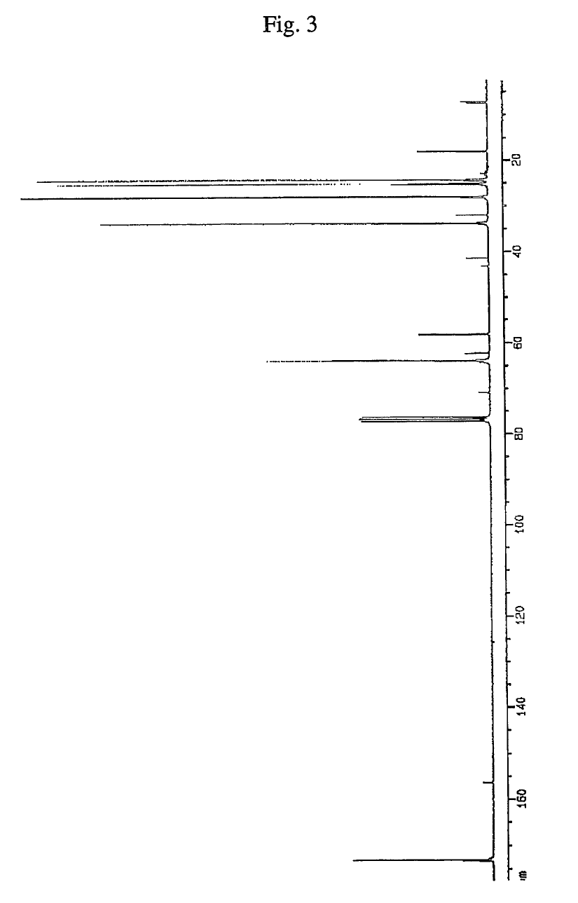

The polymer thus obtained was identified by IR and NMR spectroscopic analyses and the results are shown in FIGS. 1 to 3.

0.1 g of polymer A and 0.9 g of methylsilsesquioxane having a molecular weight of 10,000 g/mol were homogeneously mixed to obtain a mixture sample (sample no. MS1-10). Then, the mixture was spin-coated on a silicon substrate at a rate of 1,000 to 5,000 rpm to generate a 100 μm thick film. The resulting film was heated at a heating rate of 2° C./min to 400° C. and maintained at 400° C. for 60 min. Then, the film was cooled down at the same rate of the heating rate to obtain a methylsilsesquioxane film containing nano-pores.

Experiment 1

Two elements were used to measure the dielectric constant of the film obtained. The first was a MIM (metal/insulator/metal) element having a 1.2 cm×3.8 cm slide glass substrate and a bottom Al electrode deposited thereon to a thickness of 5 mm. The mixture of MSSQ (methylsilsesquioxane) and polymer A was spin coated on the substrate, and then the coated substrate was cured and a top Al electrode was coated thereon to a thickness of 1 mm.

The second was a MIS (metal/insulator/semiconductor) element, which was prepared by arranging a Si-wafer as a bottom electrode, spin-coating the MSSQ/(polymer A) mixture thereon and depositing a top Al electrode thereon.

The dielectric constant obtained using two elements was 1.840±0.010 as measured with HP 4194A (frequency: 1 MHz).

### EXAMPLE 2

### Polymerization of a Polymer Having Formula (VIII) and Preparation of a Silsesquioxane Polymer Film Using the Same

The procedure of Example 1 was repeated except for using 20 g (175 mmol) of ε-caprolactam, 0.9 g (3.6 mmol) of di(pentaerythritol) and stannous 2-ethyl hexanoate [0.01 mole equivalent based on di(pentaerythritol)]. After the reaction, the star-shaped 6-brigde polymer containing hydrogen as X in formula (VIII) was obtained at a yield of 90%. The molecular weight of the polymer was 8,000 g/mol.

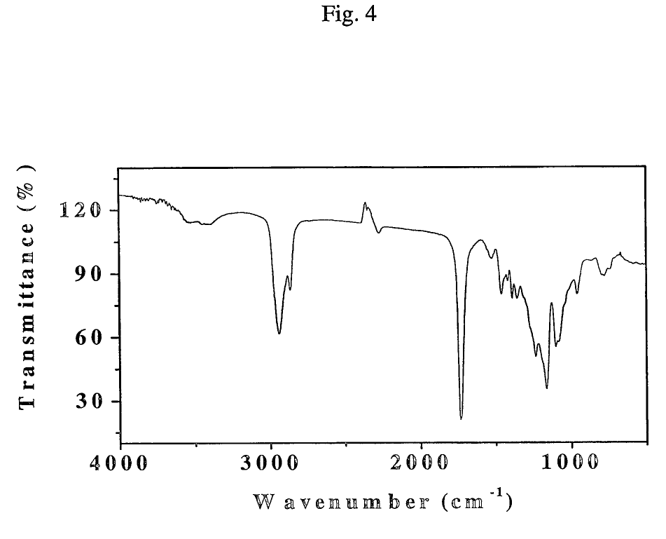

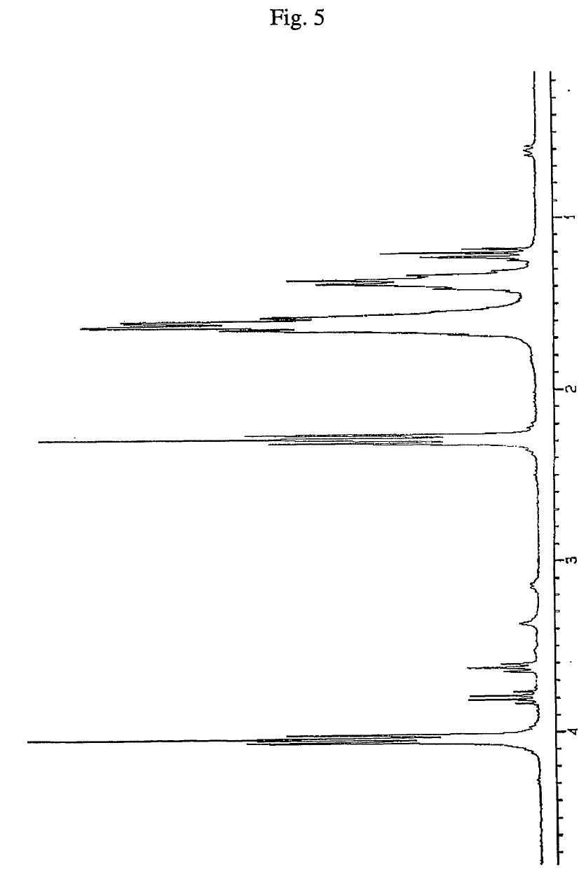

10 g of the polymer obtained was reacted with 8.0 g of excess 3-isocyanatopropyl triethoxysilane by the same procedure of Example 1 to obtain 6-bridged polymer (polymer B) having —OCONH—(CH₂)₃—Si(OC₂H₅)₃ as X in formula (VIII). Polymer B thus obtained was identified by IR and NMR spectroscopic analyses, which are shown in FIGS. 4 to 6.

0.1 g of polymer B and 0.9 g of methylsilsesquioxane having a molecular weight of 10,000 g/mol were reacted as in Example 1 to obtain a methylsilsesquioxane film. The dielectric constant measured using the elements obtained as in Example 1 was 1.830±0.010.

### EXAMPLE 3 to 64

The procedure of Example 1 was repeated except for using a different polymer in various amounts to obtain various star-shaped polymers and silsesquioxane polymer films, as shown in Tables 1A to 1C.

As illustrated in Tables 1A to 1C, the dielectric constant of the resulting polymer film decreases as the amount of the star-shaped polymer used as a pore introducer increases.

TABLE 1A

| | | | | Amount of | | |
|---|---|---|---|---|---|---|
| | | Silane | No. of | star-shaped | Kind and amount of | Dielectric |
| Example | R—(OH)ₙ | compound | bridges | polymer(g) | Silicate polymer(g) | constant |
| 1 | DTM | 3-IPTE | 4 | 0.1 | Methylsilsesquioxane | 1.840 ± 0.010 |
| | | | | | 0.9 | |
| 2 | DPET | 3-IPTE | 6 | 0.1 | Methylsilsesquioxane | 1.830 ± 0.010 |
| | | | | | 0.9 | |
| 3 | DTM | 3-IPTE | 4 | 0.2 | Methylsilsesquioxane | 1.800 ± 0.020 |
| | | | | | 0.8 | |
| 4 | DTM | 3-IPTE | 4 | 0.3 | Methylsilsesquioxane | 1.650 ± 0.030 |
| | | | | | 0.7 | |
| 5 | DTM | 3-IPTE | 4 | 0.4 | Methylsilsesquioxane | 1.440 ± 0.050 |
| | | | | | 0.6 | |
| 6 | DPET | 3-IPTE | 6 | 0.2 | Methylsilsesquioxane | 1.800 ± 0.020 |
| | | | | | 0.8 | |
| 7 | DPET | 3-IPTE | 6 | 0.3 | Methylsilsesquioxane | 1.630 ± 0.010 |
| | | | | | 0.7 | |
| 8 | DPET | 3-IPTE | 6 | 0.4 | Methylsilsesquloxane | 1.440 ± 0.010 |
| | | | | | 0.6 | |
| 9 | DTM | 3-IPTE | 4 | 0.1 | Hydrogensilsesquioxane | 1.840 ± 0.020 |
| | | | | | 0.9 | |
| 10 | DTM | 3-IPTE | 4 | 0.2 | Hydrogensilsesquioxane | 1.790 ± 0.020 |
| | | | | | 0.8 | |
| 11 | DTM | 3-IPTE | 4 | 0.3 | Hydrogensilsesquioxane | 1.650 ± 0.030 |
| | | | | | 0.7 | |
| 12 | DTM | 3-IPTE | 4 | 0.4 | Hydrogensilsesquioxane | 1.450 ± 0.050 |
| | | | | | 0.6 | |
| 13 | DPET | 3-IPTE | 6 | 0.1 | Hydrogensilsesquioxane | 1.840 ± 0.020 |
| | | | | | 0.9 | |
| 14 | DPET | 3-IPTE | 6 | 0.2 | Hydrogensilsesquioxane | 1.810 ± 0.030 |
| | | | | | 0.8 | |
| 15 | DPET | 3-IPTE | 6 | 0.3 | Hydrogensilsesquioxane | 1.640 ± 0.030 |
| | | | | | 0.7 | |
| 16 | DPET | 3-IPTE | 6 | 0.4 | Hydrogensilsesquioxane | 1.430 ± 0.050 |
| | | | | | 0.6 | |
| 17 | DTM | 3-GPDME | 4 | 0.1 | Methylsilsesquioxane | 1.840 ± 0.020 |
| | | | | | 0.9 | |
| 18 | DTM | 3-GPDME | 4 | 0.2 | Methylsilsesquioxane | 1.790 ± 0.020 |
| | | | | | 0.8 | |
| 19 | DTM | 3-GPDME | 4 | 0.3 | Methylsilsesquioxane | 1.670 ± 0.040 |
| | | | | | 0.7 | |
| 20 | DTM | 3-GPDME | 4 | 0.4 | Methylsilsesquioxane | 1.430 ± 0.050 |
| | | | | | 0.6 | |

TABLE B

| | | | | Amount of | | |
|---|---|---|---|---|---|---|
| | | Silane | No. of | star-shaped | Kind and amount of | Dielectric |
| Example | R—(OH)ₙ | compound | bridges | polymer(g) | Silicate polymer(g) | constant |
| 21 | DPET | 3-GPDME | 6 | 0.1 | Methylsilsesquioxane | 1.840 ± 0.020 |
| | | | | | 0.9 | |
| 22 | DPET | 3-GPDME | 6 | 0.2 | Methylsilsesquioxane | 1.810 ± 0.020 |
| | | | | | 0.8 | |
| 23 | DPET | 3-GPDME | 6 | 0.3 | Methylsilsesquioxane | 1.640 ± 0.030 |
| | | | | | 0.7 | |
| 24 | DPET | 3-GPDME | 6 | 0.4 | Methylsilsesquioxane | 1.450 ± 0.050 |
| | | | | | 0.6 | |
| 25 | DTM | 3-GPDME | 4 | 0.1 | Hydrogensilsesquioxane | 1.840 ± 0.020 |
| | | | | | 0.9 | |
| 26 | DTM | 3-GPDME | 4 | 0.2 | Hydrogensilsesquioxane | 1.800 ± 0.020 |
| | | | | | 0.8 | |
| 27 | DTM | 3-GPDME | 4 | 0.3 | Hydrogensilsesquioxane | 1.640 ± 0.040 |
| | | | | | 0.7 | |
| 28 | DTM | 3-GPDME | 4 | 0.4 | Hydrogensilsesquioxane | 1.430 ± 0.050 |
| | | | | | 0.6 | |
| 29 | DPET | 3-GPDME | 6 | 0.1 | Hydrogensilsesquioxane | 1.830 ± 0.020 |
| | | | | | 0.9 | |
| 30 | DPET | 3-GPDME | 6 | 0.2 | Hydrogensilsesquioxane | 1.790 ± 0.030 |
| | | | | | 0.8 | |
| 31 | DPET | 3-GPDME | 6 | 0.3 | Hydrogensilsesquioxane | 1.660 ± 0.040 |
| | | | | | 0.7 | |
| 32 | DPET | 3-GPDME | 6 | 0.4 | Hydrogensilsesquioxane | 1.450 ± 0.050 |
| | | | | | 0.6 | |
| 33 | DTM | 3-GPMDE | 4 | 0.1 | Methylsilsesquioxane | 1.840 ± 0.020 |
| | | | | | 0.9 | |
| 34 | DTM | 3-GPMDE | 4 | 0.2 | Methylsilsesquioxane | 1.810 ± 0.020 |
| | | | | | 0.8 | |
| 35 | DTM | 3-GPMDE | 4 | 0.3 | Methylsilsesquioxane | 1.640 ± 0.040 |
| | | | | | 0.7 | |
| 36 | DTM | 3-GPMDE | 4 | 0.4 | Methylsilsesquioxane | 1.440 ± 0.050 |
| | | | | | 0.6 | |
| 37 | DPET | 3-GPMDE | 6 | 0.1 | Methylsilsesquioxane | 1.850 ± 0.020 |
| | | | | | 0.9 | |
| 38 | DPET | 3-GPMDE | 6 | 0.2 | Methylsilsesquioxane | 1.800 ± 0.020 |
| | | | | | 0.8 | |
| 39 | DPET | 3-GPMDE | 6 | 0.3 | Methylsilsesquioxane | 1.630 ± 0.030 |
| | | | | | 0.7 | |
| 40 | DPET | 3-GPMDE | 6 | 0.4 | Methylsilsesquioxane | 1.440 ± 0.050 |
| | | | | | 0.6 | |
| 41 | DTM | 3-GPMDE | 4 | 0.1 | Hydrogensilsesquioxane | 1.850 ± 0.020 |
| | | | | | 0.9 | |
| 42 | DTM | 3-GPMDE | 4 | 0.2 | Hydrogensilsesquioxane | 1.790 ± 0.020 |
| | | | | | 0.8 | |

TABLE 1C

| | | | | Amount of | | |
|---|---|---|---|---|---|---|
| | | Silane | No. of | star-shaped | Kind and amount of | Dielectric |
| Example | R—(OH)ₙ | compound | bridges | polymer(g) | Silicate polymer (g) | constant |
| 43 | DTM | 3-GPMDE | 4 | 0.3 | Hydrogensilsesquioxane | 1.660 ± 0.020 |
| | | | | | 0.7 | |
| 44 | DTM | 3-GPMDE | 4 | 0.4 | Hydrogensilsesquioxane | 1.440 ± 0.020 |
| | | | | | 0.6 | |
| 45 | DPET | 3-GPMDE | 6 | 0.1 | Hydrogensilsesquioxane | 1.850 ± 0.020 |
| | | | | | 0.9 | |
| 46 | DPET | 3-GPMDE | 6 | 0.2 | Hydrogensilsesquioxane | 1.800 ± 0.030 |
| | | | | | 0.8 | |
| 47 | DPET | 3-GPMDE | 6 | 0.3 | Hydrogensilsesquioxane | 1.650 ± 0.040 |
| | | | | | 0.7 | |
| 48 | DPET | 3-GPMDE | 6 | 0.4 | Hydrogensilsesquioxane | 1.450 ± 0.050 |
| | | | | | 0.6 | |
| 49 | DTM | 3-GPMDM | 4 | 0.1 | Methylsilsesquioxane | 1.840 ± 0.020 |
| | | | | | 0.9 | |
| 50 | DTM | 3-GPMDM | 4 | 0.2 | Methylsilsesquioxane | 1.800 ± 0.020 |
| | | | | | 0.8 | |
| 51 | DTM | 3-GPMDM | 4 | 0.3 | Methylsilsesquioxane | 1.640 ± 0.040 |
| | | | | | 0.7 | |
| 52 | DTM | 3-GPMDM | 4 | 0.4 | Methylsilsesquioxane | 1.450 ± 0.050 |
| | | | | | 0.6 | |
| 53 | DPET | 3-GPMDM | 6 | 0.1 | Methylsilsesquioxane | 1.840 ± 0.020 |
| | | | | | 0.9 | |
| 54 | DPET | 3-GPMDM | 6 | 0.2 | Methylsilsesquioxane | 1.800 ± 0.020 |
| | | | | | 0.8 | |
| 55 | DPET | 3-GPMDM | 6 | 0.3 | Methylsilsesquioxane | 1.650 ± 0.030 |
| | | | | | 0.7 | |
| 56 | DPET | 3-GPMDM | 6 | 0.4 | Methylsilsesquioxane | 1.440 ± 0.050 |
| | | | | | 0.6 | |
| 57 | DTM | 3-GPMDM | 4 | 0.1 | Hydrogensilsesquioxane | 1.840 ± 0.020 |
| | | | | | 0.9 | |
| 58 | DTM | 3-GPMDM | 4 | 0.2 | Hydrogensilsesquioxane | 1.810 ± 0.020 |
| | | | | | 0.8 | |
| 59 | DTM | 3-GPMDM | 4 | 0.3 | Hydrogensilsesquioxane | 1.660 ± 0.040 |
| | | | | | 0.7 | |
| 60 | DTM | 3-GPMDM | 4 | 0.4 | Hydrogensilsesquioxane | 1.440 ± 0.050 |
| | | | | | 0.6 | |
| 61 | DPET | 3-GPMDM | 6 | 0.1 | Hydrogensilsesquioxane | 1.840 ± 0.020 |
| | | | | | 0.9 | |
| 62 | DPET | 3-GPMDM | 6 | 0.2 | Hydrogensilsesquioxane | 1.800 ± 0.030 |
| | | | | | 0.8 | |
| 63 | DPET | 3-GPMDM | 6 | 0.3 | Hydrogensilsesquioxane | 1.640 ± 0.040 |
| | | | | | 0.7 | |
| 64 | DPET | 3-GPMDM | 6 | 0.4 | Hydrogensilsesquioxane | 1.440 ± 0.050 |
| | | | | | 0.6 | |

Footnote:
DTM: di(trimethylol) propane
DPET: di(pentaerythritol)
3-IPTE: 3-isocyanatopropyl triethoxy silane
3-GPDME: 3-glycidoxypropyl dimethylethoxy silane
3-GPMDE: 3-glycidoxypropyl methyldiethoxy silane
3-GPMDM: 3-glycidoxypropyl methyldimethoxy silane

According to the present invention, a star-shaped polymer having not only a central ether group but also alkoxy silane groups can be advantageously used as a pore generating agent to attain a silicate polymer film having evenly distributed nano-pores of 10 nm or smaller and an ultra low dielectric constant of below 2.0. Then, the inventive silicate polymer film containing nano-pores therein can be used as a high efficient insulating material with a low dielectric constant in a semiconductor or an electrical circuit.

While the invention has been described with respect to the above specific examples, it should be recognized that various modifications and changes may be made to the invention by those skilled in the art which also fall within the scope of the invention as defined by the appended claims.

What is claimed is:

1. A polymer represented by formula (I): 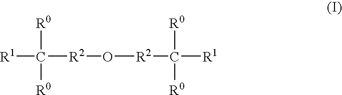
wherein R^{o} is —CH₂O—[CO—(CH₂)ₙ—O]ₘ—X, —CH₂O—[CH₂O]₃ₘ—X, —CH₂O—[(CH₂)ₙ—O]ₘ—X or —CH₂O—[CONH—(CH₂)ₙ]ₘ—X;
X is SiR³ₖ (OR⁴)₃₋ₖ;
R¹ is C₁₋₅ alkyl or R^{o};
R² is C₁₋₄ alkylene or arylene;
R³ and R⁴ are each independently C₁₋₅ alkyl; and
n is an integer in the range of 2 to 5, m is an integer in the range of 2 to 20 and k is an integer in the range of 0 to 2.

2. The polymer of claim 1, wherein R² is CH₂.

3. The polymer of claim 2, wherein R^{o} is —CH₂O—[CO—(CH₂)₅—O]ₘ—X.

4. The polymer according to claim 1, wherein the weight averaged molecular weight (Mw) of the polymer is in the range of 500 to 20,000.

5. A method of preparing the polymer represented by formula (I) of claim 1, comprising conducting a ring open polymerization of a cyclic monomer selected from the compounds of formula (III) to (VI) and a polyhydric alcohol of formula (II), and reacting the resulting polymer with a silane compound represented by SiR³ₖ(OR⁴)₃₋ₖ: 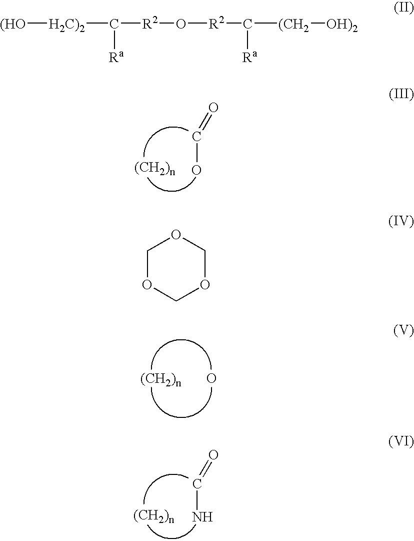
wherein R^{a} is C₁₋₅ alkyl or CH₂OH;
R² is C₁₋₄ alkylene or arylene; and
n is an integer in the range of 2 to 5.

6. The method according to claim 5, wherein the polyhydric alcohol is di(trimethylolpropane), di(pentaerythritol) or a derivative thereof.

7. The method according to claim 5, wherein the cyclic monomer is a compound of formula (III).

8. The method according to claim 5, wherein the silane compound is selected from the group consisting of 3-isocyanatopropyl triethoxy silane, 3-glycidoxypropyl dimethylethoxy silane, 3-glycidoxypropyl methyldiethoxy silane and 3-glycidoxypropyl methyldimethoxy silane, and a mixture thereof.

9. A method of preparing a polymer composite film of a low dielectric constant containing nano pores, which comprises conducting a sol-gel reaction between a polymer of claim 1 and a silicate polymer, followed by thermal decomposition of the resulting polymer.

10. The method according to claim 9, wherein the silicate polymer is methylsilsesquioxane, ethylsilsesquioxane or hydrogensilsesquioxane.

11. The method according to claim 10, wherein the silicate polymer is obtained by conducting a sol-gel reaction between one or more monomers selected from the group consisting of trichloroethane, methyltrimethoxysilane, methyltriethoxysilane, methyldimethoxysilane, ethyltriethoxysilane, ethyltrimethoxysilane, ethyldiethoxysilane, ethyldimethoxysilane, bistrimethoxysilylethane, bistriethoxysilylethane, bistriethoxysilylmethane, bistriethoxysilyloctane and bistrimethoxysilylhexane.

12. The method according to claim 9, wherein the mixing ratio by weight of the polymer of claim 1 and the silicate polymer ranges from 1:99 to 50:50.

13. The method according to claim 9, wherein the thermal decomposition is carried out at a temperature ranging from 200 to 500° C. under an inert gas atmosphere or vacuum.
